(19) United States
(12) Patent Application Publication
(10) Pub. No.: US 2015/0225199 A1
(43) Pub. Date: Aug. 13, 2015

(54) Process and Apparatus for Joining Flexible Components

(71) Applicant: The Procter & Gamble Company, Cincinnati, OH (US)

(72) Inventor: Uwe Schneider, Cincinnati, OH (US)

(21) Appl. No.: 14/689,372

(22) Filed: Apr. 17, 2015

Related U.S. Application Data
(63) Continuation of application No. 13/315,369, filed on Dec. 9, 2011.
(60) Provisional application No. 61/424,951, filed on Dec. 20, 2010.

(51) Int. Cl. B65H 29/24; B65G 47/52

(52) U.S. Cl. CPC B65H 29/243; B65G 47/525; B65H 29/245

(57) ABSTRACT

A process and apparatus for handling flexible components during manufacturing of an assembled article. The process and apparatus involve at least one transfer of the flexible components from one support surface to another. Control of the position and orientation of the flexible components during transfer from one support surface to another may be managed through the spacing between the support surfaces and/or coordinated air pressure changes.

### CROSS REFERENCE TO RELATED APPLICATION

This application is a continuation of U.S. application Ser. No. 13/315,369, filed on Dec. 9, 2011, which claims the benefit of U.S. Provisional Application No. 61/424,951, filed on Dec. 20, 2010, which is incorporated herein by reference.

### FIELD OF THE INVENTION

This disclosure relates generally to a process and apparatus for joining flexible components. The process and apparatus may be used, for example, to join flexible, lightweight components of an absorbent article. The process and apparatus may be used at high speeds.

### BACKGROUND OF THE INVENTION

Disposable garments, in particular, but not exclusively, disposable absorbent articles, are often pieced together from several discrete components. For several reasons, including wearer comfort and cost containment, disposable garments may be formed from lightweight, flexible materials. For example, disposable garments may be made from relatively low basis weight non-woven materials. These materials may provide characteristics such as hand, drapeability, softness, breathability, strength, durability, and the like. However, handling these lightweight, flexible materials prior to assembly into a unitary article may be challenging. In particular, it may be difficult to control loose, floppy components as they are assembled.

The control of loose, floppy components may be more challenging at high speeds, or when relatively large pieces are used, because these materials may be more likely to move, bend, fold, or shift relative to their intended positions. Such movement may impair the process capability with regard to accurate placement of the components. For example, if components are unintentionally folded or bent during the process, they may be seamed in that unintended position resulting in an article which may be asymmetrical, non-functional, or both.

Vacuum surfaces, such as vacuum drums or vacuum conveyors, have been used to pull loose, floppy components against a surface during manufacturing. Strong airflow through a drum or conveyor can be used to generate forces which tend to hold the components in the desired location against the drum or conveyor, and have been somewhat successful in maintaining the position and configuration of components while they are associated with a particular piece of equipment. However, components of disposable garments may be handled by more than one piece of equipment or more than one component of an equipment line. For example, a component may be cut or otherwise formed from a stock feed, further modified (as by the application of elastics, adhesives, or other adjunct components), transported (including possible changes in speed, position, or orientation), and joined to yet other components. It is not typically practical to maintain vacuum-like forces on the component throughout all of these discrete processing steps. For example, the component may be transferred between different drums or conveyors during processing, resulting in at least brief periods during the transfer when vacuum control is impractical or impossible.

There remains a need for a process and/or apparatus which reduces changes in position, orientation, and configuration of lightweight, flexible parts during processing, including transfer of the component from one piece of equipment to another.

### SUMMARY OF THE INVENTION

In some aspects, the disclosure relates to an apparatus for transferring discrete components during assembly of an article. The apparatus may comprise two continuous moving surfaces. A distance between the two continuous moving surfaces may be greater than the uncompressed height of the components being transferred between the two continuous moving surfaces, and less than 20 mm. In some embodiments, the apparatus may comprise a first surface. The first surface may have at least three portions. Each portion may be in fluid communication with a subjacent air chamber. At least two of the three portions may be in fluid communication with different subjacent air chambers. A vacuum air chamber may be subjacent at least one of the three portions. A blow-off air chamber may be subjacent at least one of the three portions.

In some aspects, the disclosure relates to a method for controlling discrete, flexible components during an assembly process. The method may comprise the following steps: applying a vacuum beneath a surface, such that a discrete, flexible component is urged toward the surface by the vacuum; reducing or eliminating the vacuum by introducing a first volume of air at a first positive pressure beneath the surface; and introducing a second volume of air at a second positive pressure to create a displacement force urging the discrete, flexible component away from the surface.

Further, in some aspects, the disclosure relates to a method for controlling discrete, flexible components during an assembly process. The method may comprise the following steps: rotating a rotary drum about an axis of rotation, wherein the rotary drum comprises a surface surrounding the axis of rotation and one or more chambers underlying the surface and in fluid communication with the surface, wherein the one or more chambers comprise a vacuum chamber, a primary blow-off chamber, and a secondary blow-off chamber; applying a vacuum in the vacuum chamber, such that a discrete, flexible component is urged toward the surface by the vacuum; reducing or eliminating the vacuum by introducing a first volume of air at a first positive pressure in the primary blow-off chamber; and introducing a second volume of air at a second positive pressure in the secondary blow-off chamber to create a displacement force urging the discrete, flexible component away from the surface of the rotary drum.

Further still, in some aspects, the disclosure relates to a method for controlling discrete, flexible components during an assembly process. The method may comprise the following steps: rotating a rotary drum about an axis of rotation, wherein the rotary drum comprises a first surface surrounding the axis of rotation and one or more chambers underlying the first surface and in fluid communication with the first surface, wherein the one or more chambers comprise a vacuum chamber and a blow-off chamber; applying a vacuum in the vacuum chamber, such that a discrete, flexible component is urged toward the first surface by the vacuum; reducing or eliminating the vacuum by introducing a first volume of air at a first positive pressure in the vacuum chamber; introducing a second volume of air at a second positive pressure in the blow-off chamber to create a displacement force urging the discrete, flexible component away from the first surface of the rotary drum; and transferring the discrete, flexible component to a second surface adjacent the surface of the rotary drum.

### BRIEF DESCRIPTION OF THE DRAWINGS

FIG. 1 is a schematic view of an exemplary converting process.

FIG. 2 is a schematic view of the relationship between the size and spacing of two adjacent support drums.

FIG. 3 is an exemplary absorbent article.

FIG. 4A is a schematic plan view of an absorbent article chassis.

FIG. 4B is a schematic plan view of an absorbent article chassis and two discrete ear panels.

FIG. 4C is a schematic plan view of an absorbent article chassis and one discrete ear panel.

FIG. 5A is a partial, schematic side view of an exemplary absorbent article.

FIG. 5B is a partial, schematic side view of an exemplary absorbent article.

FIG. 6A is a partial plan view of an exemplary continuous web having die cut longitudinal sides.

FIG. 6B is a partial plan view of the continuous web of FIG. 6A, having lateral edge cuts.

FIG. 6C is a partial plan view of the continuous web of FIG. 6B, having final lateral cuts.

FIG. 6D is a partial plan view of an alternative to the continuous web of FIG. 6A, having complete die cuts.

FIG. 7 is a schematic side view of an exemplary vacuum drum.

FIG. 8 is a perspective view of an exemplary flexible knife holder.

FIG. 9A is a schematic view of an exemplary cutting process.

FIG. 9B is a schematic view of an exemplary cutting process.

### DETAILED DESCRIPTION OF THE INVENTION

As used herein, “lightweight” refers to materials having a basis weight less than about 200 grams per square meter (gsm). Basis weight can be measured using the EDANA standard test method #40.3-90.

As used herein, “flexible” refers to materials having a stiffness of less than 6N when measured according to ASTM Standard Test Method D4032-08 for Stiffness of Fabric by the Circular Bend Procedure.

As used herein, “vacuum” refers to the generation of air flow through a surface, such that lightweight, flexible materials placed adjacent to the surface tend to be pulled by the air flow against the surface.

As used herein, “disposable absorbent articles” refers to devices used to capture and/or contain body exudates, such as urine, feces, menstrual fluid, and the like. A disposable absorbent article may be adapted to be worn on or against the body of a wearer. Exemplary disposable absorbent articles include diapers; training pants; adult incontinence articles; catamenial products; pads such as those used to absorb sweat, breast milk, or other body fluids; absorbent bandages; and the like. Disposable absorbent articles may be intended for single use (e.g., worn and discarded regardless of whether the absorbent article is soiled or otherwise damaged or destroyed), or may be intended for a limited number of re-uses (e.g., worn repeatedly or continuously if not soiled or damaged). A disposable absorbent article may not be intended to be washed or otherwise reconditioned or repaired for reuse.

As used herein, “disposable clothing” refers to articles such as hospital gowns; examination gowns or tops; disposable travel clothing, such as disposable underwear and socks; and industrial clothing, such as non-linting clothing for use in “cleanrooms” or clothing which is worn only in a specific setting, so as not to transfer chemicals outside that specific setting. Disposable clothing may be intended for single use (e.g., worn and discarded regardless of whether the clothing protector is soiled or otherwise damaged or destroyed), or may be intended for a limited number of re-uses (e.g., worn repeatedly if not soiled or damaged). Disposable clothing may not be intended to be washed or otherwise reconditioned or repaired for reuse.

As used herein, “disposable clothing protectors” refers to articles such as bibs, aprons, coveralls, and the like, which may be worn over other garments to protect the garments from spills, stains, soils, or other contamination. Disposable clothing protectors may be intended for single use (e.g., worn and discarded regardless of whether the clothing protector is soiled or otherwise damaged or destroyed), or may be intended for a limited number of re-uses (e.g., worn repeatedly if not soiled or damaged). A disposable clothing protector may not be intended to be washed or otherwise reconditioned or repaired for reuse.

As used herein, “uncompressed” refers to a material or article not under the influence of an external force tending to densify or compress the material or article.

In some aspects, the present disclosure relates to a process for handling lightweight, flexible components during assembly of an article comprising the lightweight, flexible components. The process may involve placing the lightweight, flexible components adjacent to a vacuum surface. The process may involve transferring the lightweight, flexible components to at least a second surface during assembly of the article. The process may involve placement of the first and second surfaces within a fixed distance from each other.

In some aspects, the present disclosure relates to an apparatus for handling lightweight, flexible components during assembly of an article comprising the lightweight, flexible components. The apparatus may comprise two or more distinct surfaces, a first surface and a second surface. The first surface and/or the second surface may use a vacuum to secure the lightweight, flexible components during assembly of the article. The first surface and the second surface may be within a fixed distance from each other.

In some aspects, the present disclosure relates to an article assembled using the process and/or apparatus described herein.

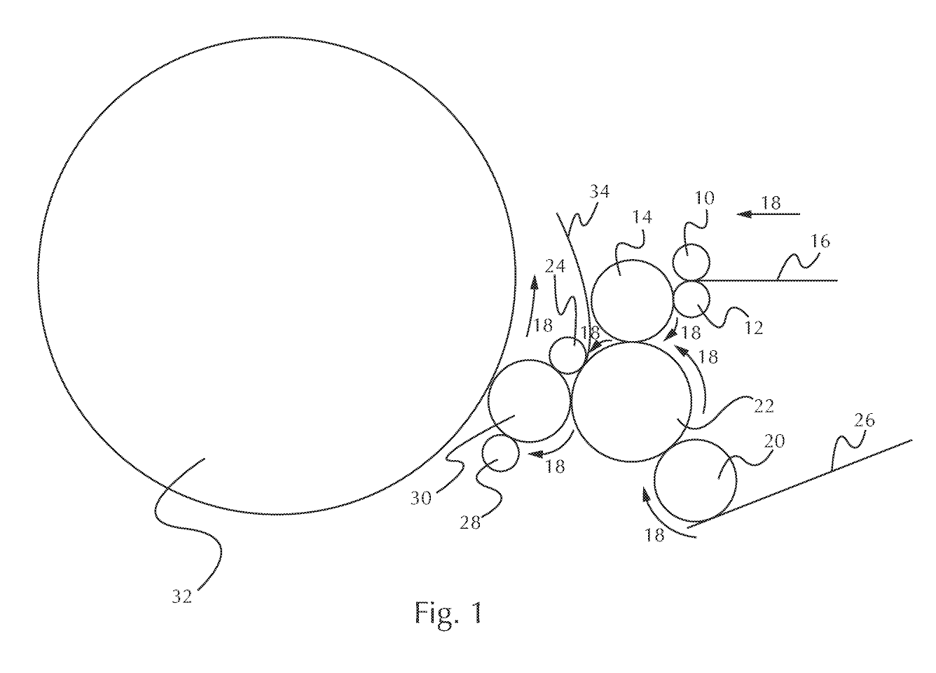

As mentioned above, a manufacturing process for combining lightweight, flexible components may involve transferring the components to distinct apparatuses. An exemplary process suitable for forming a disposable absorbent article is shown schematically in FIG. 1. A continuous web stock 16 is fed in machine-direction (MD) 18 to a cutting operation executed by cutter anvil 10 and cutter knife roll 12. The discrete components cut from continuous web stock 16 may be repositioned, reoriented, or spaced apart from one another by a separate apparatus, such as spacer 14. The discrete components severed from continuous web stock 16 may be combined with discrete components severed from continuous web stock 26, which may be repositioned, reoriented, or spaced apart from one another by an apparatus such as spacer 20. Spacer 14 and/or 20 may be any apparatus which spreads or positions discrete components, such as, but not limited to, an apparatus for holding and spreading a web as described, for example, in WO 00/34164, or an apparatus for adjusting the distance between discrete parts, as described, for example, in U.S. Pat. No. 6,811,019, or an apparatus or combination of apparatuses which perform multiple functions, such as spreading and distancing discrete parts. An apparatus for changing the up-facing surface of a part may be used with or as spacer 14. Such an apparatus is described, for example, in provisional U.S. patent applications titled APPARATUS FOR TURNING A PLIABLE MEMBER OF AN ARTICLE MOVING ALONG A MACHINE DIRECTION; and METHOD FOR TURNING A PLIABLE MEMBER OF AN ARTICLE MOVING ALONG A MACHINE DIRECTION, each filed on Dec. 20, 2010, in the name of Yoichiro Yamamoto, under attorney docket numbers 11958PQ, and 11963PQ, respectively.

The discrete components from each of continuous web stock 16 and continuous web stock 26 may be combined at combining drum 22, and joined together. Roll 24 may, for example, be a nip roller that uses pressure to combine the discrete components. Of course, roll 24 could also be an adhesive applicator, an ultrasonic welder, a heated nip roller, or any other sort of joining apparatus suitable for the article under construction. Roll 24 is shown as a single apparatus; however, one or more apparatus may be used, for example, to apply an adhesive and to press the discrete components together.

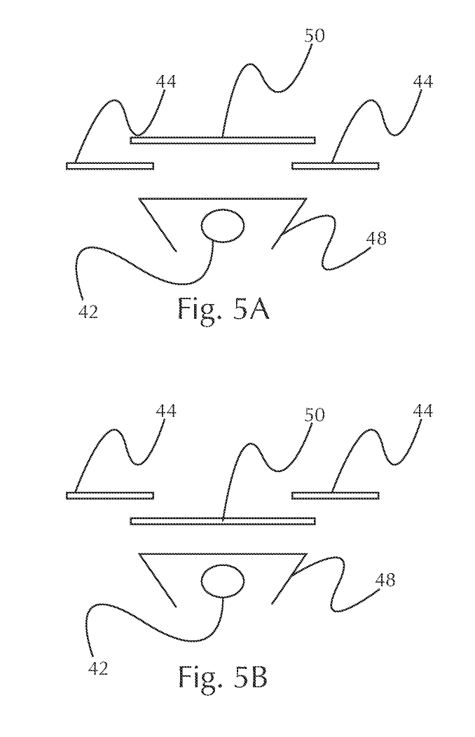

Optionally, additional components, in the form of a continuous web stock 34 or discrete components (not shown), may be fed into the process. For example, continuous web stock 26 may comprise an absorbent core 42 and core wrap 48, as shown in FIG. 5A, where continuous web stock 16 may be formed into an ear panel or discrete ear panels 44, and continuous web stock 34 may comprise an additional layer 50, such as a backsheet, which may be functional (e.g., fluid-handling or contributing to product fit) or aesthetic (e.g., providing improved appearance, including layers which improve the perception of softness or enable more aesthetically pleasing embossing or printing patterns) or both. In some other embodiments, as shown in FIG. 5B, continuous web stock 26 may comprise an absorbent core 42, core wrap 48, and additional layer 50, and continuous web stock 16 may be formed into an ear panel or discrete ear panels 44. In FIGS. 5A and 5B, core wrap 48 is shown as a c-wrap of a single material, however, it should be understood that the core wrap may comprise one or more layers of one or more materials, such as a dusting layer and an acquisition layer, may completely or partially enclose the absorbent core 42, and may be joined or unjoined to the absorbent core 42 or other components of the absorbent article. If the combined components are in the form of a continuous web, anvil 28 and knife roll 30 may be used to sever the combined components into individual articles. The individual articles may be delivered to yet another apparatus 32 for further processing. Apparatus 32 may, for example, be a folder, a seamer, a spacer, a packager, or another unit or combination of units.

The articles under construction may be disposable articles, such as disposable absorbent articles, disposable clothing, or disposable clothing protectors. Such articles may be formed of lightweight, flexible materials. The nature of the materials will vary with the article being formed. For example, hydrophilic materials may be used to provide absorbency or resistance to oleaginous stains and hydrophobic materials may be used to provide water-resistance. In some articles, a combination of hydrophilic and hydrophobic materials may be used. For example, a disposable absorbent article, such as a diaper, may comprise layers of material with different properties to provide absorbency to contain body exudates such as urine, and water repellency to prevent “rewet” of body exudates against the skin after the exudates have been absorbed into the article.

Suitable lightweight materials may include non-woven materials. The term “nonwoven” as used herein refers to a fabric made from continuous filaments and/or discontinuous fibers. Nonwoven fabrics include those made by carding staple fibers, airlaying or wet laying staple fibers and via extrusion processes such as spunbonding and melt blowing, and combinations thereof. The nonwoven fabric can comprise one or more nonwoven layers, wherein each layer can include continuous filaments or discontinuous fibers. Nonwovens can also comprise bi-component fibers, which can have side-by-side, sheath-core, segmented pie, ribbon, or islands-in-the-sea configuration. The sheath, if present, may be continuous or non-continuous around the core. The fibers may be natural, synthetic, or a mix of natural and synthetic fibers, including individual fibers which include both natural and synthetic components. Exemplary natural fibers include, but are not limited to cellulosic fibers, such as cotton, jute, flax, ramie, sisal, hemp, bamboo, and combinations thereof, including modified fibers which have been chemically and/or mechanically treated. Exemplary synthetic materials include, but are not limited to polypropylene, including isotactic polypropylene, atactic polypropylene, and mixtures thereof; and polyethylene, including linear polyethylene, branched polyethylene, poly(ethylene terephthalate), viscose, nylon, and combinations thereof, including modified fibers which have been chemically and/or mechanically treated.

Lightweight, flexible materials may have a tendency to flex, bend, move, or otherwise shift position or orientation during processing. This tendency may be exacerbated in high-speed processes, where high-speed and/or high-volume air flow from moving apparatus may increase the probability that lightweight, flexible materials will be subjected to forces which lift them away from support structures, such as conveyors or rotating drums, during processing. In extreme cases, the materials may not complete the transfer. That is, the materials may not successfully transfer to the second or receiving conveyor or drum. In other cases, the parts may form s-curves, folds, wrinkles, or other potentially undesirable structures, or may shift position, for example by rotating slightly relative to the machine direction. These movements may have a negative impact on downstream processing, resulting in process errors (such as jammed equipment) or product defects.

So-called “vacuum drums,” pull ambient air through the drum surface, creating a force tending to press materials against the drum, have been used with some success to better control the position and orientation of components during processing. However, in multi-step processes where the components are transferred to different apparatus, it may be impractical or impossible to maintain vacuum control of the parts at all times. For example, there may be brief periods of time when a part is transferred from one conveyor, drum, or other support surface to another. During that time, the part may again be subject to air movement or other forces which tend to disturb the position or orientation of the part. A vacuum drum (or other support surface employing “vacuum” control) may be adapted to also blow air out of the drum through the surface, such that parts on the surface are subject to a “blow-off” phase. Thus, a vacuum drum may use bi-directional air flow to hold a part close to the drum for some period of time or arc or line of motion, and then push the part away from the drum, as when the part is transferred to another support structure. A blow-off phase may facilitate transfer, but may itself introduce air movement that makes it difficult to control the position and orientation of parts during transfer from one apparatus to another.

The transfer of lightweight, flexible parts between apparatus during process may be facilitated by controlling the distance between apparatus, such as conveyors, drums, or other support surfaces. Placing the apparatus as close to one another as possible would seem to make it easier to keep the parts in position during the transfer from one apparatus to another. However, if the apparatus are too close, or even touching, there may be unintended or undesirable compression of parts as they pass from one apparatus to another. Of course, excessively large distances between apparatus may exacerbate problems with misplaced.

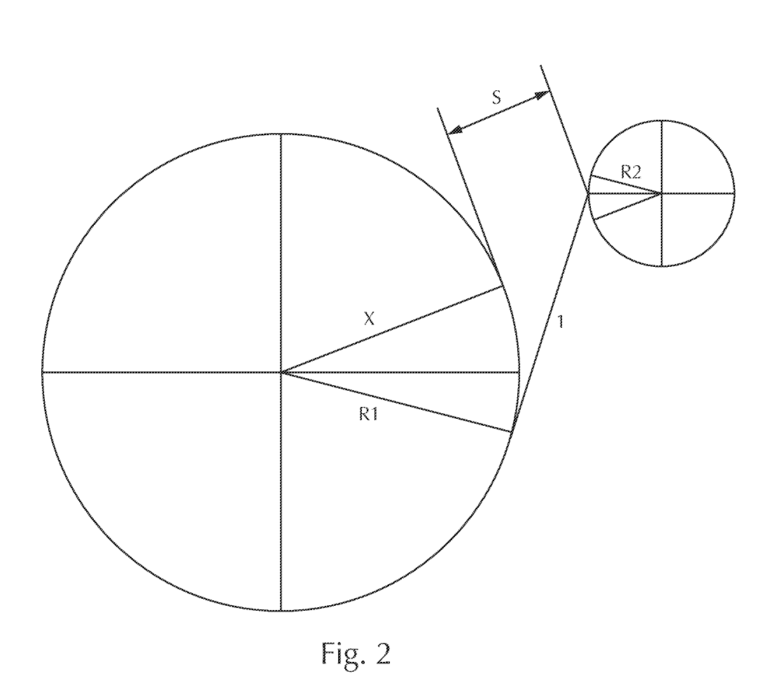

It was believed that lightweight, flexible components such as those often used to make disposable garments, could best be controlled by spacing adjacent support structures to control the unsupported web span between the support structures. The unsupported web span can be calculated by the formula

$$T = ( R 1 + R 2 ) * tan ( {cos}^{- 1} ( \frac{R 1 + R 2}{X} ) ) ,$$

where, as shown in FIG. 2, T is the unsupported web span between adjacent support structures, R1 is the radius of the first support structure, R2 is the radius of the second support structure, and X is the distance between the centers of the support structures. Reference S in FIG. 2 is the space between the surfaces of the support structures, and can be calculated as X−(R1+R2).

As shown by the calculations presented in the chart below, the magnitude of the unsupported web span T increases more rapidly than the space between the drum surfaces, particularly as the larger radius of the radii of the two drums increases. Intuitively, that unsupported span should be important to the control of the part, and, therefore, the ideal spacing between drum surfaces should be varied to control for T. Surprisingly, however, good control can be achieved by controlling only S across a range of drum sizes, as shown by Examples 1-3. To maintain control of flexible parts, S may be limited to less than 20 mm, or less than 15 mm, or less than 10 mm, or less than 5 mm, with improved control as S is decreased. S may be held to a minimum distance greater than the caliper of the flexible parts being transferred, that is, greater than the cumulative, uncompressed thickness of the flexible parts being transferred, so as not to compress the parts between the drum surfaces, if compression is not desirable. Thus, S may be greater than 0, or, if no compression is desired, greater than the caliper of the flexible parts being transferred, or the uncompressed height of the flexible parts being transferred. Where the flexible parts are nonwovens, S may be greater than 0.25 mm, or greater than 0.5 mm, or greater than 1 mm, depending upon the parts being transferred. A nip or compression step, such as a nip or compression roll, may be used in conjunction with one or more surfaces being used to transfer parts. That is, the surfaces between which the part is being transferred may not compress the parts, but other the parts may be compressed in other steps before or after the transfer.

| | | |
|---|---|---|
| Example 1 | Example 2 | Example 3 |

| R1 | 79.6 mm | R1 | 159 mm | R1 | 159 mm |
|---|---|---|---|---|---|
| R2 | 159 mm | R2 | 159 mm | R2 | 1273 mm |
| S | T | S | T | S | T |
| 0.5 | 15 | 0.5 | 18 | 0.5 | 38 |
| 1 | 22 | 1 | 25 | 1 | 54 |
| 2 | 31 | 2 | 36 | 2 | 76 |
| 5 | 49 | 5 | 57 | 5 | 120 |
| 10 | 70 | 10 | 80 | 10 | 170 |
| 15 | 86 | 15 | 99 | 15 | 208 |
| 20 | 100 | 20 | 115 | 20 | 240 |
| 25 | 112 | 25 | 129 | 25 | 269 |
| 30 | 123 | 30 | 141 | 30 | 295 |
| 35 | 134 | 35 | 153 | 35 | 319 |
| 40 | 144 | 40 | 165 | 40 | 341 |
| 45 | 153 | 45 | 175 | 45 | 362 |
| 50 | 162 | 50 | 185 | 50 | 382 |

Control can be further maximized by coordinating the surface speed of the first and second support surfaces (e.g., drums, conveyors, etc.). It may be desirable that the surface speed of the first and second support surfaces are within 10% of each other, or within 5% of each other. For materials with elastic properties or low tensile strengths, it may be desirable to maintain the surface speed of the first and second support surfaces within 1-2% of each other.

As described above, bi-directional air flow, in a “vacuum” mode and a “blow-off” mode, may be used to help transfer flexible parts from one surface or apparatus to another surface or apparatus. The vacuum mode may involve evacuating one or more chambers of air underlying a surface. The evacuation may result in a reduced air pressure in the chamber or chambers as low as 0 (zero) to 350 millibar (mbar). Of course, the layout of the apparatus, the speed at which the apparatus is run, and the size and characteristics of the flexible parts to be transferred will all influence the desired degree of evacuation, and the nominal pressure desired may be higher than 350 mbar. The surface may be in fluid communication with the evacuated chamber, such that the lower pressure in the evacuated chamber (relative to the air “outside” or above the surface) tends to pull a flexible part on the surface in, toward the center of a drum-shaped surface or the bottom of a flat surface. For example, the surface may include holes, mesh, slats, or other air-permeable elements to allow air to flow through the surface. Of course, the total area of the surface occupied by open spaces, such as holes or the spaces between supports in a mesh or slat pattern, should be small enough to support the materials or parts being transferred.

If used, a blow-off mode may itself have two phases, including a primary blow-off and a secondary blow-off. The primary blow-off may use positive pressure to neutralize the vacuum created by the evacuation of the chamber by repressurizing the chamber to approximately ambient conditions (i.e., typical atmospheric pressure for the location of the apparatus). Thus, the primary blow-off may discontinue the pull of the vacuum on the surface. The secondary blow-off may use additional positive pressure to pressurize the vacuum chamber or a separate blow-off chamber such that the chamber has a positive pressure relative to ambient conditions. For example, an apparatus at sea-level may have an ambient air pressure of approximately 1,000 mbar. The vacuum mode may depressurize the vacuum chamber to approximately 50 to 100 mbar. The primary blow-off may repressurize the vacuum chamber to approximately 1,000 mbar, and the secondary blow-off may pressurize a separate, blow-off chamber to approximately 0.5 to 6 bar (or 500 to 6,000 mbar).

The separation of primary and secondary blow-off modes may be helpful, for example, in high speed operations, where it may be difficult to cancel the vacuum and create positive pressure to help displace a flexible part from a surface. Using two distinct blow-off modes may help with timing, allowing for a precise hand-off from one surface to another, where the secondary blow-off at a first surface is nearly instantaneously accompanied by the achievement of a steady-state vacuum in a second surface, so that a flexible part moving between the two surfaces is predictably and controllably influenced by air flow and/or air pressure in the interstice between the surfaces. This control may be further refined by using separate chambers for the vacuum mode and secondary blow-off phase.

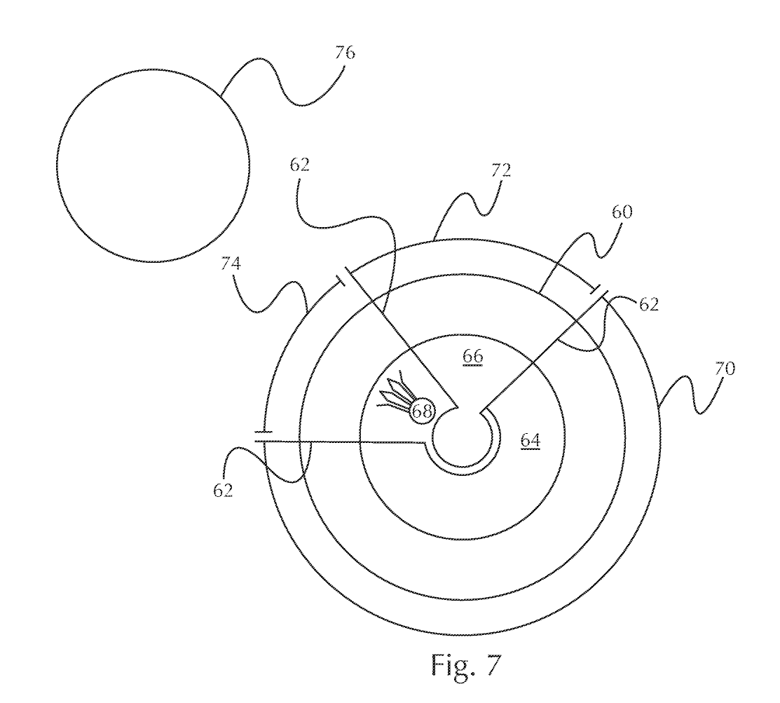

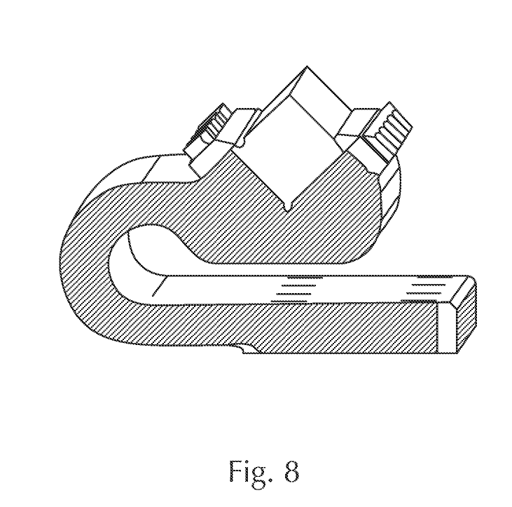

As shown in FIG. 7, an apparatus may have a surface 60 for transporting one or more flexible components. The surface 60 may be in fluid communication with air chambers 64, 66, 68 underlying the surface 60. The fluid communication means may comprise mesh, screens, or other air-permeable materials. Surface 60 may be partitioned into three zones, modes, or phases, shown by dividers 62. Dividers 62 may be conceptual, and may not have any physical manifestation. A first mode is a vacuum mode influencing portion 70 of surface 60. In FIG. 7, surface 60 is shown as the surface of a rotary drum, and, thus, portion 70 of surface 60 is an arc. It should be understood that surface 60 may be substantially linear, in which case portion 70 would be a length or width rather than an arc. The vacuum mode may manifest in that portion 70 of surface 60 overlying vacuum chamber 64. Vacuum chamber 64 may have a large volume relative to blow-off chamber 68. Vacuum chamber 64 may also have relatively large channels (not shown) connecting vacuum chamber 64 to a pump or fan and to surface 60, so facilitate the evacuation of the relatively large volume chamber. The large void volumes of vacuum chamber 64 help to reduce air velocity and increase the negative, static pressure acting on a flexible part traveling along surface 60.

Primary blow-off chamber 66 may similarly have relatively large volume and relatively large channels (not shown), to facilitate the movement of air into the chamber at relatively low air velocity. Thus, vacuum chamber 64 and primary blow-off chamber 66 can provide rapid ramp-down or ramp-up of pressure, respectively, to facilitate high-speed rotation of surface 60, with relatively low air flow at surface 60. During the vacuum mode along portion 70 and the primary blow-off mode along portion 72 of surface 60, it may be desirable for a flexible part at surface 60 to maintain its position and orientation. In contrast, during the secondary blow-off mode along portion 74 of surface 60, it may be desirable for a flexible part at surface 60 to transfer rapidly from surface 60 to another surface (not shown). Thus, secondary blow-off chamber 68 may be characterized by relatively low volume and relatively small channels, relative to vacuum chamber 64 and primary blow-off chamber 66. The smaller volume and channels allow for rapid air flow, to create dynamic pressure and air movement to dislodge a flexible part traveling along surface 60 and facilitate the transfer of the flexible part to another surface.

A similar three-phase system on the surface 76 to which the flexible part is being transferred can be coordinated with the three-phase system of surface 60, such that a flexible part in the secondary blow-off portion 74 of surface 60 is simultaneously or nearly instantaneously exposed to a steady-state vacuum portion of surface 76. For example, the delay between the flexible part encountering the secondary blow-off portion 74 of surface 60 and encountering the vacuum portion of surface 76 may be about 50 milliseconds, or even 20 milliseconds. The position of the vacuum and blow-off portions of surface 60 and/or surface 76 may be adjusted with sliding inserts, such that the position of a vacuum or blow-off portion is shifted along the arc of surface 60 and/or surface 76, or the arc length of the portion is somewhat lengthened or shortened relative to the position of the portion using a different insert or different insert position. The most efficient positions of the vacuum and blow-off portions of the surface 60 and/or surface 76 are dependent largely on the speed at which the transfer takes place.

An exemplary embodiment of the system and process discussed above is further described in the context of manufacturing a disposable absorbent article, in particular, a training pant-style disposable absorbent article. It should, however, be appreciated that the techniques described are adaptable to manufacture a wide variety of disposable garments and other articles of manufacture.

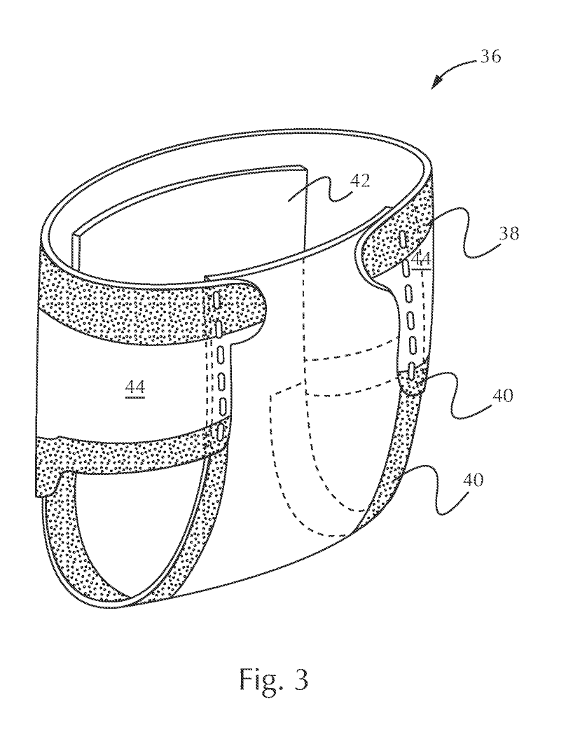

As shown in FIG. 3, a disposable absorbent article 36 may have an absorbent core 42. Disposable absorbent article 36 may have a waist edge 38 generally corresponding to the waist of the wearer when worn, and a leg edge 40 encircling the leg of the wearer when worn. Disposable absorbent article 36 may have side panels 44, which may also be referred to as ear panels or ear flaps. In the embodiment shown in FIG. 3, side panels 44 are integral to disposable absorbent article 36. That is, side panels 44 are an extension of other materials making up disposable absorbent article 36 (which may include the backsheet 84 and/or the topsheet 82, as described below). An exemplary disposable absorbent article is described in greater detail, for example, in provisional U.S. patent applications titled, DISPOSABLE ABSORBENT PANT WITH EFFICIENT BELTED DESIGN; DISPOSABLE ABSORBENT PANT WITH EFFICIENT BELTED DESIGN AND ADJUSTABLE SIZE MANUFACTURABILITY; and DISPOSABLE ABSORBENT PANT WITH EFFICIENT DESIGN AND CONVENIENT SINGLE SECTION SIDE STRETCH PANELS, each filed on Dec. 20, 2010, in the name of Ashton, et al., under attorney docket numbers 11957P, 11961P, and 11962P, respectively.

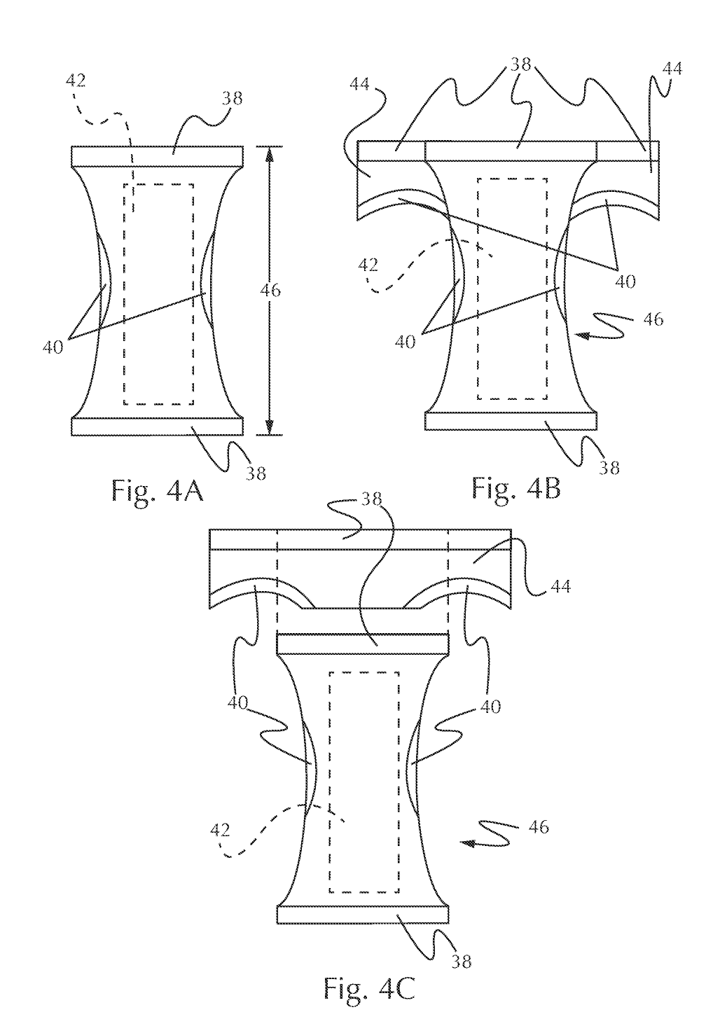

As shown in FIGS. 4A-4C, side panels 44 may also be discrete components which are joined to a chassis 46 during the manufacture of absorbent article 36. For example, FIG. 4A shows a chassis 46 comprising a portion of waist edge 38, a portion of leg edge 40, and absorbent core 42. Side panels 44 may be added as two or more discrete panels, as shown in FIG. 4B, or may be added as one discrete panel extending laterally across chassis 46, as shown in FIG. 4C. The embodiments shown in FIGS. 4B and 4C each present challenges in terms of controlling the position and orientation of side panels 44 during processing. The embodiment of FIG. 4B requires the control of multiple pieces (e.g., at least chassis 46 or a portion thereof and each of at least two side panels 44) as the pieces are fed into a joining process and during the joining process. The embodiment of FIG. 4C requires the control of a larger side panel 44, which may be more inclined to fold or bend, and requires the alignment of a longer portion of the waist edge 38 when chassis 46, or a portion thereof, is joined to side panel 44. It is desirable, of course, to align not only waist edge 38 across the joint between chassis 46 and side panel 44, but also the leg edge 40 across the joint between chassis 46 and side panel 44.

Considering FIG. 1 and FIGS. 4A-4C, it may be that continuous web stock 16 is used to form side panel 44 (which, of course, may include two or more panels), continuous web stock 26 is used to form a discrete waist section or waist band applied at or proximate waist edge 38, and continuous web stock 34 includes multiple chassis 46 assemblies. Side panel 44, waist edge 38 component, if used, and chassis 12 may be divided into discrete absorbent articles 36 or absorbent article sub-assemblies by cutter knife roll 30. Of course, additional components may be added in additional steps (not shown), which may occur before, during, or after joining side panel 44 to chassis 46. Absorbent article 36 may include a variety of structures to improve the fit and/or function of absorbent article 36. For example, absorbent article 36 may comprise stretch films in the chassis, side panels, waistband, or elsewhere; toilet training aids, including wetness indicators and wetness sensation members; barrier leg cuffs; odor control components; lotions or other compounds providing benefits related to cleaning and/or skin health; and the like.

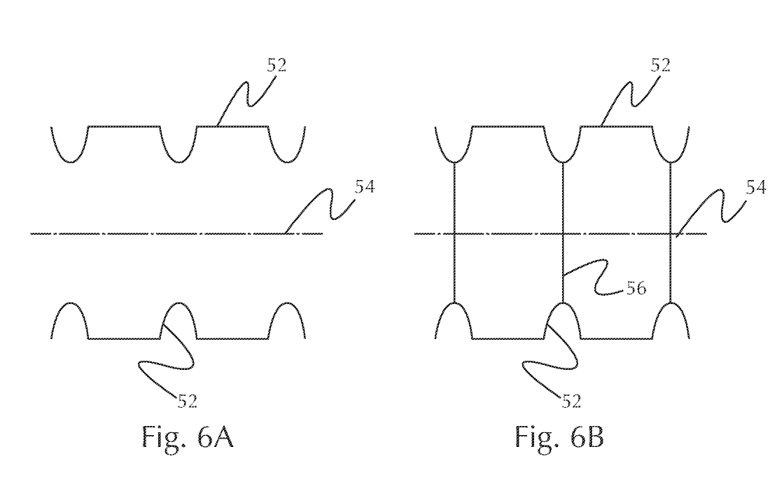

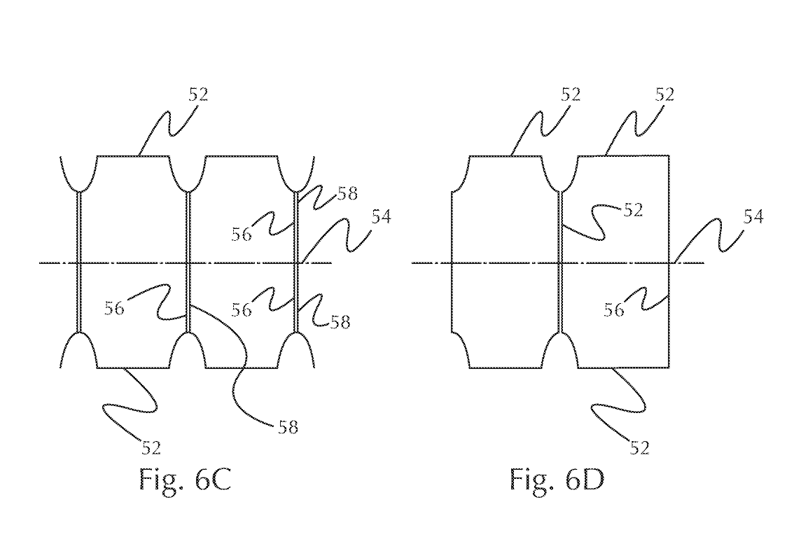

If a single, continuous side panel 44 is used, each side panel may be cut from the continuous web material in a two-step process, as shown in FIGS. 6A and 6B. For example, the longitudinal sides 52, parallel to longitudinal axis 54, of each side panel 44 may be die-cut using a fixed blade or die knife. As shown in FIG. 6A, longitudinal axis 54 is parallel to machine direction 18. However, the articles may be assembled in a cross-direction roughly perpendicular to the machine direction 18 using the same principles described herein.

In contrast, lateral edges 56 may be cut using a flex knife, such as a flexible blade and/or a flexible blade holder. It may be desirable to use two or more cutting steps because the relatively long width of side panel 44 may require greater pressure between the cutting knife and cutting anvil to separate the parts along the relatively high contact area (as compared to separate, discrete side panels 44, as shown in FIG. 4B). If a single, continuous cutting apparatus is used to cut the entire width of a continuous side panel 44, greater pressure is needed to separate the parts along the greater contact area, relative to smaller parts (such as discrete side panels) or smaller cutting lengths. The higher pressure may cause the cutting apparatus, or other, adjacent equipment, to bounce, particularly, but not exclusively, if the process is run at high speeds. Bouncing may exacerbate shifting, bending, or folding of components, either proximal the cutting apparatus or at other points upstream or downstream in the process. The higher pressure may increase the routine wear of a die cutter, thereby reducing the useful life span of the die-cut blade or die cutter. A third step may be used to remove any excess material between the initial lateral edge 56 and the final edge of the assembled article. For example, a final cutting step may be performed when the article is fully assembled (i.e., all discrete parts have been joined to the article) or nearly fully assembled. As suggested by FIG. 6C, the final cut 58 may be made contemporaneous with the initial lateral edge 56 cut, or immediately before or immediately after the lateral edge 56 cut. The final cut 58, shown in FIG. 6C, may give the article a more tailored or more neatly finished appearance.

FIG. 8 shows an exemplary flexible knife holder 78, in a “gooseneck” shape. The shape of the knife holder 78 of FIG. 8 gives the knife holder 78 flexibility, which in turn allows the knife holder 78 to absorb much of the energy from the lateral cutting force applied to the blade 80 by an anvil or anvil drum. Thus, a flexible knife holder 78 may reduce the bounce or oscillation associated with a relatively high pressure cut.

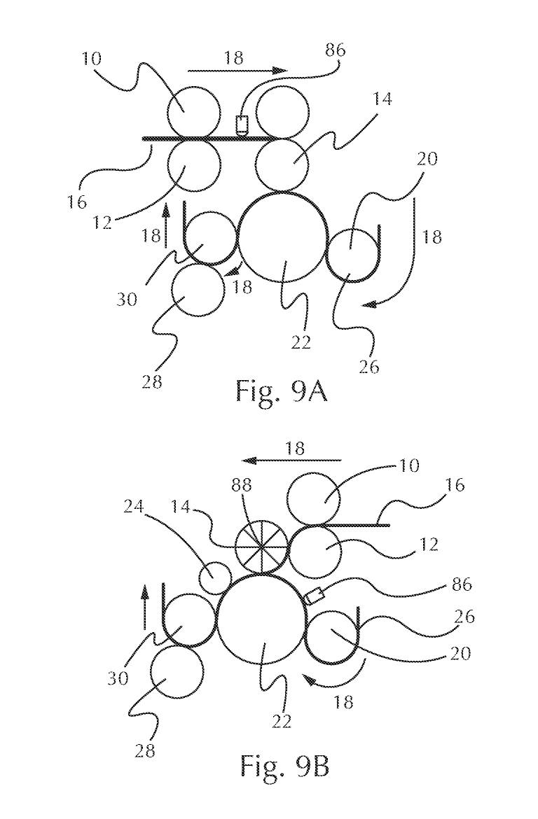

A two-step process may be performed using an apparatus like the one shown in FIG. 9A. Continuous material web 16 may be fed in machine direction 18 to a die cutter anvil 10 and die cutter knife roll 12. Adhesive applicator 86 may apply a construction adhesive to the die cut parts 88 (which may, for example, be a side panel 44) before transfer roll 22 and before or after cut-and-slip spacer 14, which may include a flexible knife or flexible knife holder to make the lateral edge cut 56. Of course, in some embodiments, no adhesive applicator 86 may be used, or adhesive applicator 86 may be positioned to apply adhesive to a component other than die cut parts 88. A separate continuous web 26, such as a continuous web of multiple chassis 46, may be transferred to transfer roll 22 from a parts manipulator, such as an apparatus 20 for spreading waist edge 30 in the cross-direction (roughly perpendicular to machine direction 18). The parts may be combined on transfer roll 22, and then forwarded to final cutter anvil 28 and final cutter knife roll 30, or to alternate and/or additional processes (not shown). As suggested by FIGS. 6A, 6B, and 9A, the flexible cut may be made before or after the die cut, if the cut is made in two steps.

Of course, the entire perimeter of side panel 44 may be die cut, even if side panel 44 is a single, continuous side panel, as shown in FIG. 6D. This may reduce the number of processing steps required, as all cuts (except, perhaps, for the optional final cut) are made in one step. An exemplary die knife suitable for forming contoured cuts, and adapted to minimize the bounce or oscillation of a long die cut edge, is described, for example, in U.S. Pat. No. 7,146,893 to Aichele. Such a die knife may be a cylindrical die (for pressing against an anvil roller), having an outer sleeve and an inner sleeve. The inner sleeve may be braced against the outer sleeve to increase the rigidity of the cutting anvil. The inner sleeve may be tensioned in a direction parallel to the axis of rotation, to bias the inner and outer sleeves such that the cylindrical die knife is less likely to jump, spring, or oscillate due to lateral cutting forces. Alternatively, other elements of the cutting apparatus, such as a rotating shaft which drives the cylindrical die or supporting structures for the rotating shaft may be biased to decrease springing of the equipment due to lateral cutting forces. A die cutter adapted to minimize bouncing may be useful even for relatively shorter cuts, particularly when the die cutter is intended to run at very high speeds. For disposable articles, such as disposable diapers or catamenial products, very high speed equipment may produce in excess of 800 or even 1,000 parts per minute.

A one-step, die cut process may be performed, for example, as shown in FIG. 9B. Continuous material web 16 may be fed in machine direction 18 to a die cutter anvil 10 and die cutter knife roll 12. Die cut parts 88 may be transferred to parts spacer 14, and then further transferred to transfer roll 22. Separate continuous web material 26 may be fed to apparatus 20, which may cut, spread, or cut and spread parts. Adhesive applicator 86, if used, may apply a construction adhesive to the parts of continuous web material 26. If adhesive is used, die cut parts 88 (which may, for example, be a side panel 44) and continuous web material 26 may be compressed by nip roller 24 before being transferred to cutter anvil 28 and cutter knife roll 30, which may, for example, make a final knife cut 58 as shown in FIG. 6C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for controlling discrete, flexible components during an assembly process, the method comprising:
applying a vacuum beneath a surface, such that a discrete, flexible component is urged toward the surface by the vacuum;
reducing or eliminating the vacuum by introducing a first volume of air at a first positive pressure beneath the surface; and
introducing a second volume of air at a second positive pressure to create a displacement force urging the discrete, flexible component away from the surface.

2. The method of claim 1, wherein a second vacuum is applied beneath a second surface, such that the discrete, flexible component is urged toward the second surface by the second vacuum.

3. The method of claim 2, wherein the second vacuum is applied beneath the second surface within about 0 to 50 milliseconds of the introduction of the second volume of air at a second positive pressure.

4. The method of claim 2, wherein the second surface is spaced a distance of no more than 20 mm from the first surface.

5. The method of claim 4, wherein the discrete, flexible components are side panels for a disposable absorbent article.

6. A method for controlling discrete, flexible components during an assembly process, the method comprising:
rotating a rotary drum about an axis of rotation, wherein the rotary drum comprises a surface surrounding the axis of rotation and one or more chambers underlying the surface and in fluid communication with the surface, wherein the one or more chambers comprise a vacuum chamber, a primary blow-off chamber, and a secondary blow-off chamber;
applying a vacuum in the vacuum chamber, such that a discrete, flexible component is urged toward the surface by the vacuum;
reducing or eliminating the vacuum by introducing a first volume of air at a first positive pressure in the primary blow-off chamber; and
introducing a second volume of air at a second positive pressure in the secondary blow-off chamber to create a displacement force urging the discrete, flexible component away from the surface of the rotary drum.

7. The method of claim 6, further comprising the step of accepting the discrete, flexible component on an adjacent surface of a second rotary drum.

8. The method of claim 6, wherein the vacuum chamber is depressurized to about 50 to about 100 mbar.

9. The method of claim 6, wherein the first positive pressure may repressurize to about 1,000 mbar.

10. The method of claim 6, wherein the primary blow-off chamber is a portion of the vacuum chamber.

11. The method of claim 6, wherein the surface of the rotary drum defines one or more apertures.

12. The method of claim 6, wherein the volume of the vacuum chamber is greater than the volume of the secondary blow-off chamber.

13. A method for controlling discrete, flexible components during an assembly process, the method comprising:
rotating a rotary drum about an axis of rotation, wherein the rotary drum comprises a first surface surrounding the axis of rotation and one or more chambers underlying the first surface and in fluid communication with the first surface, wherein the one or more chambers comprise a vacuum chamber and a blow-off chamber;
applying a vacuum in the vacuum chamber, such that a discrete, flexible component is urged toward the first surface by the vacuum;
reducing or eliminating the vacuum by introducing a first volume of air at a first positive pressure in the vacuum chamber;
introducing a second volume of air at a second positive pressure in the blow-off chamber to create a displacement force urging the discrete, flexible component away from the first surface of the rotary drum; and
transferring the discrete, flexible component to a second surface adjacent the surface of the rotary drum.

14. The method of claim 13, wherein the discrete, flexible component is at least one of a side panel and a chassis.

15. The method of claim 13, wherein the discrete, flexible component is.

16. The method of claim 13, wherein the first surface and the second surface are spaced no more than 20 mm apart.

17. The method of claim 13, wherein the first and second surfaces are spaced a distance greater than the uncompressed height of the discrete, flexible component being transferred from the first surface to the second surface.

18. The method of claim 13, further comprising applying adhesive to a portion of the discrete, flexible component.

19. The method of claim 13, wherein the volume of the vacuum chamber is greater than the volume of the blow-off chamber.

20. The method of claim 13, wherein the pressure of the blow-off chamber is from about 500 to about 600 mbar.
